(19) United States
(12) Patent Application Publication
(10) Pub. No.: US 2008/0170941 A1
(43) Pub. Date: Jul. 17, 2008

(54) Wind turbine

(76) Inventors: Dwipen N. Ghosh, Mumbai (IN); Sudip Ghosh, Bettendorf, IA (US)

Correspondence Address: LAW OFFICE OF JAY R. HAMILTON, PLC., 331 W. 3RD ST., NEW VENTURES CENTER SUITE 120, DAVENPORT, IA, 52801, US

(21) Appl. No.: 11/888,234

(22) Filed: Jul. 31, 2007

Related U.S. Application Data
(60) Provisional application No. 60/821,086, filed on Aug. 1, 2006.

(51) Int. Cl. F03D 1/02

(52) U.S. Cl. 416/121

(57) ABSTRACT

A wind turbine is disclosed. The wind turbine comprises a casing with an inlet and outlet; a rotating shaft positioned within said casing wherein said rotational shaft provides rotational power to a generator; a plurality of impeller blades and guide vane blades arranged in at least one set within an interior of said casing, wherein said set comprises: a plurality of guide vane blades wherein each guide vane blade is affixed to an interior surface of said casing and to a stationary hub surrounding said rotating shaft, wherein a bearing is positioned within said stationary hub and rotationally engages an outer surface of said rotating shaft; and, a plurality of impeller blades affixed to a rotating hub, wherein said rotating hub is affixed to said rotating shaft and rotatable therewith, and wherein said plurality of impeller blades are rotatable within said casing; and, a support engaged with said casing.

### CROSS REFERENCE TO RELATED APPLICATIONS

Applicant claim priority under 35 U.S.C. § 119(e) of provisional U.S. Patent Application Ser. No. 60/821,086 filed on Aug. 1, 2006 which is incorporated by reference herein.

### FIELD OF INVENTION

The present invention relates to a new wind turbine for generating electricity. More specifically, the present invention provides for a multistage, axial flow wind turbine.

### STATEMENT REGARDING FEDERALLY SPONSORED RESEARCH OR DEVELOPMENT

No federal funds were used to develop or create the invention disclosed and described in the patent application.

### REFERENCE TO SEQUENCE LISTING, A TABLE, OR A COMPUTER PROGRAM LISTING COMPACT DISK APPENDIX

Not Applicable

### BACKGROUND OF THE INVENTION

### 1. Introduction

Design of a multistage, axial flow wind turbine is a complex phenomenon, and the design challenge is enhanced further due to unavailability of any theoretical or technical information, or any experimental data on the subject. The function of a multistage axial flow wind turbine is the same as that of commonly used horizontal-axis wind turbines (“HAWT”) generally having a rotor with three blades. However, theory of HAWT with three blades is completely different than that of multistage axial flow wind turbines. Therefore, theory or data developed for HAWT with three blades offer no guidance when to designing a multistage, axial flow wind turbine.

The source of theory for design, therefore, is derived from theory for aerodynamic design of axial flow air compressor, which is somewhat correlated to the design of multistage, axial flow wind turbines. However, axial flow air compressors and axial flow wind turbines are opposites; impellers of air compressors are rotated by external power to produce force (compressed air), whereas impellers of wind turbines are rotated by wind force to produce power. In principle, similar correlations from fluid momentum theory may be used for both axial flow compressors and wind turbines for certain engineering aspects. Accordingly, theory of blade design of axial flow air compressors may be theoretically considered to some extent for blade design of axial flow wind turbines, and the final design may depend on experimental data, including computational fluid dynamics and wind tunnel testing.

Unpredictability largely caused by fluctuating wind intensity and variable wind flow patterns greatly increases the complexity of designing multistage axial flow wind turbines. The general theory of an isolated airfoil in a potential flow is not a difficult mathematical problem. The problem becomes much more complicated when a time-unsteady fluctuating load in a cascade of airfoils is considered because the effects of the geometry of the cascade must be included in the theory in order to account for the interference effects among the blades. Because of these complicating effects, the most reliable cascade design is derived from simplified equations employing certain assumptions, or from experiment. In order to be accurate and have the greatest range of applicability, design calculations should be based on the fundamental laws of motion as much as possible.

### 2. Wind Energy Characteristics

### 2.1 Theory of Motion

Theory related to wind motion may generally be used to design of multistage axial flow wind turbines, but accurately calculating wind flow through turbine blade rows presents certain difficulties. Therefore, these calculations should be based on the fundamental laws of motion as much as possible. Thus, the fundamental theory should account for the fact that the motion of the wind has components in the three physical dimensions. It must also account for the effects of viscosity as well as time-unsteady motion. By assessing these requirements, the differential equations of motion may be derived. The Navier-Stokes equations, for example, are obtained from this procedure.

In order to obtain more easy methods of analysis, various techniques have been devised that combine simplified theories and empirical data. Simplified equations of motion have also been developed for airfoil analyses. The foundations of the simplified theories are thus the time-steady equations of the motion of a non-viscous fluid.

In design using these simplified fluid-flow equations, it is better to assume that any important effect of viscosity and time-unsteady flow can be treated as correction factors, and that the effects of viscosity are confined to thin boundary layers. The important flow properties not directly given by the simplified equations for motion should be obtained empirically.

Therefore, the simplified equations, together with the empirical data required to calculate the flow with the reasonable degree of accuracy, constitute a framework for analysis or a design system for which more details are provided below.

### 2.2 Wind Power Potential

The following equation is derived from the theory of kinetic energy of motion

$$\frac{P}{A} = \frac{1}{2} ρ {V}^{3}$$

P=wind power energy (W)
A=unit cross-section of area
ρ=air density
V=air velocity
P/A=wind power potential

The value of the air density at standard conditions (sea level at 15° C.) is 1,225 kg/m³ and is used for wind energy calculations as per the International Civil Aeronautical Organization.

Average wind power potential can be found for any convenient time period (usually month, season, or year) where wind speed and density are known according to the following relation,

$$\frac{{P}_{avg}}{A} = \frac{{\sum }_{i = 1}^{N} {P}_{t}}{AN} = \frac{1}{N} {\sum }_{i = 1}^{N} 0.5 {ρ}_{i} {V}_{i}^{3}$$

$$\frac{{P}_{avg}}{A} = \frac{{\sum }_{i = 1}^{n} {P}_{i}}{AN} = \frac{1}{N} {\sum }_{i = 1}^{N} 0.5 {ρ}_{i} {V}_{i}^{3}$$

where N is the number of observations.

Average wind power potential also may be calculated from the wind speed histogram or wind speed frequency histogram according to the following relations, respectively,

$$\frac{{P}_{avg}}{A} = \frac{0.5 {ρ}_{avg}}{N} {\sum }_{j = 1}^{C} {n}_{j} {V}_{j}^{3}$$

$$or$$

$$\frac{{P}_{avg}}{A} = 0.5 {ρ}_{avg} {\sum }_{j = 1}^{C} {f}_{j} {V}_{j}^{3}$$

wherein average value for air density is estimated
wherein average power potential is obtained, using speed frequency histogram, and
C=number of wind speed classes
fⱼ=frequency of occurrence of winds in the jth class
Vⱼ=wind speed at mid point of the jth class
nⱼ=number of observation in the jth class

Wind data in the form of histograms are used extensively for predicting wind power potential and energy output of wind turbines.

### 2.3 Conversion of Wind Energy

The simplest case of fluid flow, steady-state laminar wind flow around and individual profile (aerofoil), is first considered. At an infinite length upstream of the profile, the wind is assumed to resemble undisturbed stream lines, and the flow is characterized by a constant velocity Uₒ (see figure below). As the flow approaches the profile, its action onto the flow becomes stronger and this manifests itself in curving the lines of flow and the change in the distance between them. Consequently, on top surface of the profile, the fluid velocity increases compared with Uₒ and decreases underneath the profile. The lines of flow become suction surface boundary layers on the top of the profile and pressure surface boundary layers underneath it, so it is responsible for the action of the profile, as may be seen in FIG. 1.

The relative wind flows are the resultant vector between moving device (airfoil in this case) with translation velocity and free stream wind velocity. This relative wind flow acting on the airfoil produces lift and drag forces. The speed-ratio X is the translation velocity divided by free stream wind velocity. The expression for P is given by the following equation.

P=0.5ρU³ₒAλ[C_{L} cos δ−C_{D}(λ−sine δ)]\sqrt{1+λ²−2λ sin δ}
A=Area
ρ=Density
C_{L}=Coefficient of Lift Force
C_{D}=Coefficient of Drag force
δ=Yow angle for horizontal Axis Wind Turbine

After deriving the max power for lift as well as for drag from the above equation and upon comparison, it is well known to those skilled in the art that the lift force is many times greater than the drag force. Consequently, lifting type devices are used in wind energy conversion, and therefore the profile of turbine blades are designed in the form of an airfoil in cascade in order to have greater lifting force.

### 2.4 Wind Power Resource—Site Prediction and Selection

Wind flow variation and changes in wind direction create extremely complex systems and increase the difficulty of wind farm site selection. At some sites wind flows are highly unpredictable; at one site wind speed may be high for a few months of a given year and may be low for the remaining months, or the wind speeds may be high for a few hours of a day low for the remaining hours. Turbulence caused by wind gusts creates further complexity. These complexities or indefinite patterns of flow vary from place to place over our planet due to local geographical conditions, Along shorelines, flat terrains, hilltops, cliffs (or ridges, etc.) may be expected to have comparatively strong and stable wind flow patterns. Therefore, these areas likely have better wind energy resources when compared to areas having forest, areas that are not flat, and areas with manmade obstacles.

The following characteristics of the terrain features should help when evaluating potential sites: (1) ridge and mountain summits and also upper slopes (generally have stronger winds and less wind variation than a valley); (2) flat-topped mountains and ridges (may produce wind shear and flow separation); (3) mouths of wide valleys parallel to the prevailing wind (less wind variation than extremely short and narrow valleys or canyons); and, (4) passes perpendicular to the direction of prevailing winds, especially in the deserts near the sea coast may be useful. The characteristics of the wind resource at any potential site must be obtained by measurement.

The variation in wind speeds is estimated via a non-dimensional parameter, which is labeled the energy pattern factor, defined as:

$${K}_{e} = \frac{\frac{1}{N} ( {\sum }_{i = 1}^{N} {\overline{V}}^{3} hr )}{{( \overline{V} yr )}^{3}}$$

where Vₕᵣ and V_{yr} are the mean hourly and yearly wind speed, respectively, and N=8760 (number of hours in a year).

According to the above equation, Kₑ will always be greater than 1, as the mean of cubes of a series of numbers is greater than the mean of the series cubed. Therefore the estimation for wind power potential of a site based on yearly mean wind speed would not give the true potential when compared to the estimation for wind power potential based on mean hourly wind speed.

Besides variation of wind speeds, wind temperature varies from one day to the next and from one season to the next. Accordingly, analysis of the atmospheric boundary layer is extremely important to determine the stability of wind power. Therefore, wind statistics must be taken to access the wind power potential and to estimate the annual output.

Based on the preceding considerations, flow data collection must be carried on throughout the year continuously for a number of years in prospective sites with reasonably stable wind energy, and thereafter annual mean wind speeds of those sites are estimated to obtain wind power potential. This method of wind farm site selection is used to prepare wind energy maps or resource maps worldwide.

### 2.5 Harmonic Analysis in Fourier Transform

The statistics for wind energy potential are most accurately derived from random experiments since wind speeds, temperatures, etc. are unpredictable and since data depend on the chance or probability within certain limits of speed and time. These variations result in a stochastic process (i.e., a random process) in which the current state does not fully determine the next state.

There are many phenomena where the changes in one variable are related to changes in another variable. Such a simultaneous variation is called correlation.

As is shown in the prior art, the stochastic process may be expressed by harmonic analysis in Fourier transform of the autocorrelation function.

The application of Fourier transforms is important in wind turbine engineering because wind turbulence causes random fluctuating load and power output, and wind turbulence also causes changing stresses on the blades and supporting structure of the turbine. Analysis of wind turbulence, variance of turbulence intensity, power spectral density (analysis of frequency components, etc.), and characteristics of spatial turbulence are highly complex. Modern turbines employ rotors from 20 over 70 meters in diameter and rotate at linear tip speeds in excess of 100 m/s. This leads to a need for exhaustive study of wind turbulence from an engineering point of view.

### 3. Aerodynamic Design System of Axial Flow Compressor

By way of background, the following section reviews some of the theories related to compressor design. Several of those theories are extracted in short form herein to provide an outline for background theory regarding multistage axial flow wind turbine design.

### 3.1 Theory of Fluid Flow

Fluid flow is generally broadly grouped into one of two categories; one is an ideal fluid (having no internal friction and hence has no viscosity and is also incompressible), the second is a real fluid (having viscosity and is compressible to some extent), also called a viscous fluid. In the case of an ideal fluid, the velocity tangent to a fixed surface is usually nonzero at the surface and (for small surface curvatures) is nearly equal to the velocity at a point near the surface, as shown in (a) below. A viscous fluid adheres on the surface while flowing over it so that the velocity tangent to the surface is zero at the surface. FIG. 2 shows a schematic diagram of flow velocities at different distances from the surface for both a nonviscous flow and a viscous flow.

The velocity near the surface rapidly increases and attains the value of the free-stream velocity at a short distance from the surface, as shown in FIG. 2. The region of flow in which the local velocity is retarded is referred to as the boundary layer. The static pressure across the boundary layer is nearly constant. However, some discussion has been made herein regarding the importance of boundary-layer development in relation to compressor design procedures. A more satisfactory description of boundary-layer flow cannot be highlighted without mentioning the behavior of fluid flow in blade rows of an actual axial flow compressor. Two-dimensional boundary layer theory predicts characteristics of a boundary layer resulting from a mainstream flow that has no variation in its lateral direction. However, in an actual blade row lateral variations of the mainstream and the associated boundary layer cannot be ignored. Therefore, the occurrence of secondary flows (which arise principally from blade-end clearance, blade to blade and radial pressure gradients, centrifugal force effects, and relative motion between blades ends and annulus walls) are relevant. FIG. 3 shows some of the secondary flows present for a particular blade design.

### 3.2 Theory of Secondary Flow

Though theoretical investigation on secondary flow has been limited because of mathematical complexities, certain special aspects of secondary-flow behaviors have been treated analytically by use of simplified theories. A fair amount of progress, for example, has been made on the calculation of boundary-layer cross flows and the calculation of vorticity components associated with secondary flows in two-dimensional cascades and channels.

With only minor exceptions, secondary flows have been concerned with steady, incompressible flows. Such flows are described in their most general form by the Navier-Stokes equations along with the equation of continuity. This system of four equations in rectangular coordinate is as follows:

$$u \frac{δ u}{δ x} + v \frac{δ u}{δ y} + w \frac{δ u}{δ z} = - \frac{1}{ρ} \frac{δ P}{δ x} + γ ( \frac{{δ}^{2} u}{δ {x}^{2}} + \frac{{δ}^{2} u}{δ {y}^{2}} + \frac{{δ}^{2} u}{δ {z}^{2}} )$$

$$u \frac{δ v}{δ x} + v \frac{δ v}{δ y} + w \frac{δ v}{δ z} = - \frac{1}{ρ} \frac{δ P}{δ x} + γ ( \frac{{δ}^{2} v}{δ {x}^{2}} + \frac{{δ}^{2} v}{δ {y}^{2}} + \frac{{δ}^{2} v}{δ {z}^{2}} )$$

$$u \frac{δ w}{δ x} + v \frac{δ w}{δ y} + w \frac{δ w}{δ z} = - \frac{1}{ρ} \frac{δ P}{δ x} + γ ( \frac{{δ}^{2} w}{δ {x}^{2}} + \frac{{δ}^{2} w}{δ {y}^{2}} + \frac{{δ}^{2} w}{δ {z}^{2}} )$$

$$\frac{δ u}{δ x} + \frac{δ v}{δ y} + \frac{δ w}{δ z} = 0$$

where u, v, and w are components in the x, y and z directions, respectively, ρ is the density, P the static pressure, and γ the kinematic viscosity. Therefore one of the ways to simplify the Navier-Stokes equations greatly is to assume a non-viscous flow, which yields γ=0.

Although secondary flows are almost always a result of viscous action in a fluid, the assumption of non-viscous fluid flow is considered reasonable in certain instances, With the assumption γ=0, the flow equations are reduced to first-order equations, and it is no longer possible to satisfy the two boundary conditions for a real flow, which conditions are that normal and tangential components of the flow at a surface be zero. The single boundary condition satisfied when γ=0 is that the flow normal to the surface is zero, and hence the condition of no slip at the surface is not assured. In actual application of non-viscous flow analyses, this defect is generally of secondary importance.

### 3.3 Two-Dimensional Cascades

Five quantities determine the aerodynamic behavior of a cascade within an ideal flow. One of these is the shape of the blades, which is usually expressed in terms of the distribution of thickness and camber. Another quantity is the orientation of the blades with respect to the cascade axis. This orientation may be defined by the blade-chord angle 1 (see figure below). The third quantity is the solidity (σ=b/t), although the pith-cord ratio, the reciprocal of this number, is sometimes used. With these three quantities, the geometry of the cascade of the blades is defined. The fourth quantity identifies the direction of the flow ahead of the cascades. The relative inlet-air angle β′₁ is frequently used for this purpose, Finally, the relative Mach number of the flow at some point must be known. This quantity is also usually referred to the relative inlet flow. Theoretically, all details of flow of an ideal fluid can be determined from these data. FIG. 4 provides a sketch of a two-directional cascade for a particular blade design.

For real flows, the factors involving friction are also pertinent, which implicates the Reynolds number. The Reynolds number is usually based on the properties of the inlet flow, using the cord length as the characteristic dimension. The factors involved are the turbulence of the incoming flow and the condition of the airfoil surfaces. Because of the complicating effects of friction, the most reliable cascade data are derived from experiment rather than analysis.

One of the most important pieces of cascade data required is the deflection of the flow (β₁−β₂) because deflecting the flow is the main purpose of the cascade. Although analytical techniques have been developed and are occasionally used for determining this deflection, the greatest amount of data is obtained by experiment. A typical sample of the experimental data is shown in FIG. 5. These data were obtained for fixed values of blades shape, solidity (equal to 1.0), and inlet-air angle (equal to 45 degrees). The blade angle was varied with the magnitude of the variation being described by the angle of attack α=β₁−β_{vc}. The deflection, or turning angle, is measured by the angle Δβ=β₁−β₂.

The losses incurred by the cascade may be described in a variety of ways. The loss is measured by a drag coefficient. Note that the drag coefficient is independent of the position of the downstream measurement and that no averaging techniques are required. The total pressure loss and the increase in entropy, however, depend on the axial position of the measurements, the Mach number of the flow, and the method of averaging. For blade shapes, it has been possible to correlate the loading limit by the following equation:

D=(1−V₂/V₁)+ΔV_{θ}/2σV₁.

All the blades reached their loading limit at a value of D of approximately 0.6. This equation is simply and empirical means of estimating the downstream static pressure minus minimum static pressure on blade surface, and then dividing that value by the maximum velocity pressure on the blade surface. This formula provides an indication of the loading limit as good as or better than many other recommended empirical rules. A more fundamental approach would utilize the above equation with the actual velocity and pressure data.

### BRIEF DESCRIPTION OF THE FIGURES

FIG. 1 is a side view of an air foil within a fluid flow.

FIG. 2 provides velocity profiles for a nonviscous flow and a viscous flow.

FIG. 3 provides a perspective view indicating some of the secondary flows that may be present for a particular blade design.

FIG. 4 shows a side view of a two-directional cascade.

FIG. 5 provides a graphical representation of typical experimental data for a system with fixed values for blades shape, solidity, and inlet-air angle.

FIG. 6 provides front and side view of a four vane axial flow impeller.

FIG. 7 provides a schematic representation of a vane cascade transposed onto a plane.

FIG. 8 provides a sketch of velocity parallelograms for a vane cascade.

FIG. 9 provides a schematic view of the flow passage through a wind turbine having an area in which the blades are not uniform length.

FIG. 10 provides a schematic view of velocity parallelograms for a two-stage axial flow wind turbine.

FIG. 11 is perspective view of an exemplary embodiment of the multistage axial flow wind turbine.

FIG. 12 is a perspective view of an exemplary embodiment of the multistage axial flow wind turbine having a portion of the casing removed.

FIG. 13 is a cross-sectional view along the axis of the rotating shaft of an exemplary embodiment of the multistage axial flow wind turbine.

FIG. 13A is a cross-sectional view as in FIG. 3 further showing possible air flow patterns through the multistage axial flow wind turbine.

FIG. 14 is a cross-sectional view perpendicular to the axis of the rotating shaft of an exemplary embodiment of the multistage axial flow wind turbine.

FIG. 15 is a perspective view of an exemplary embodiment of the multistage axial flow wind turbine with a solar panel.

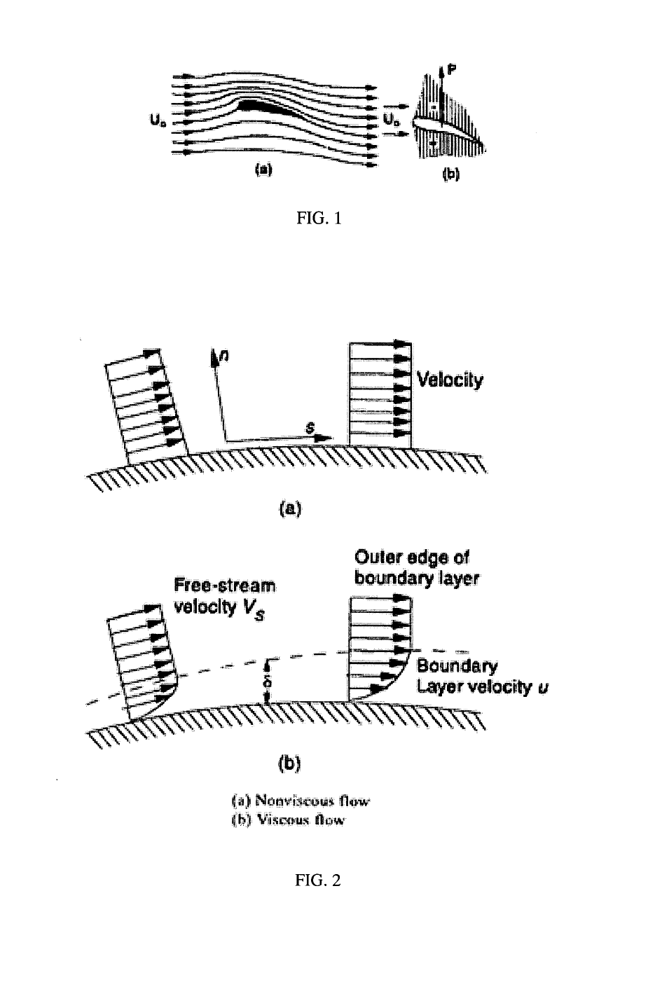

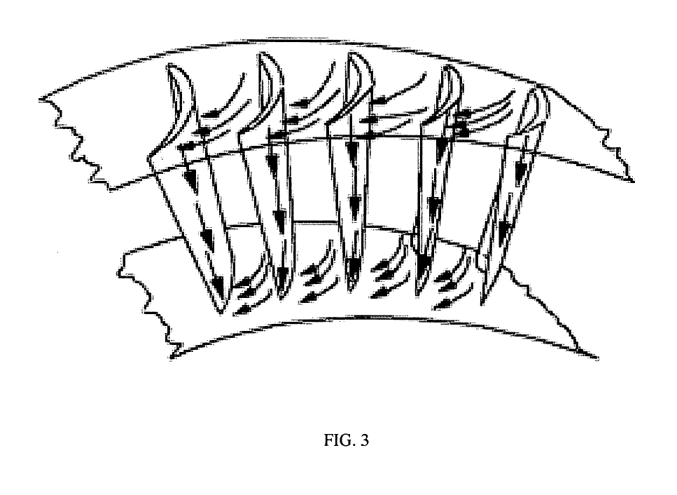

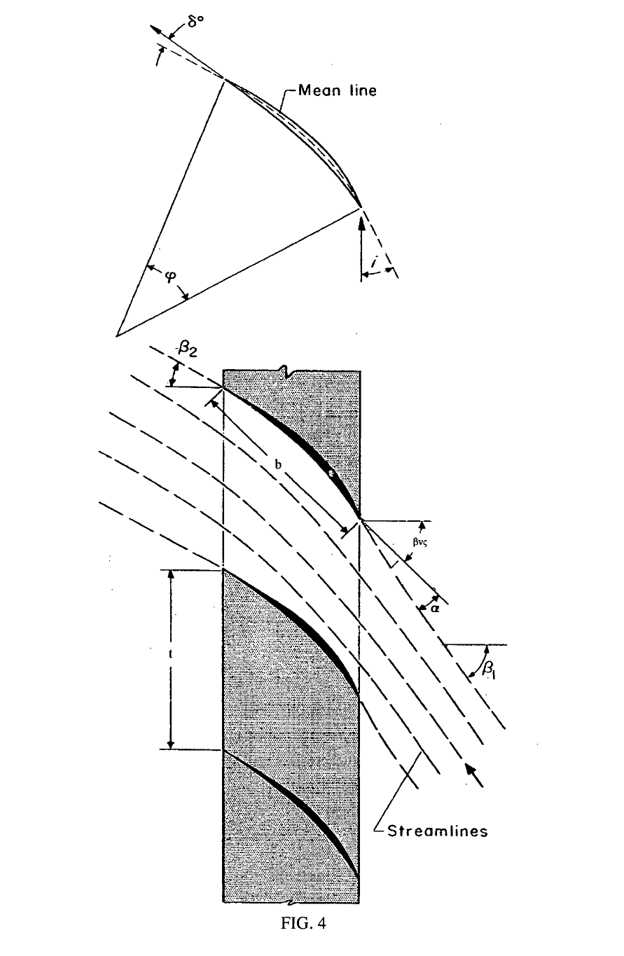

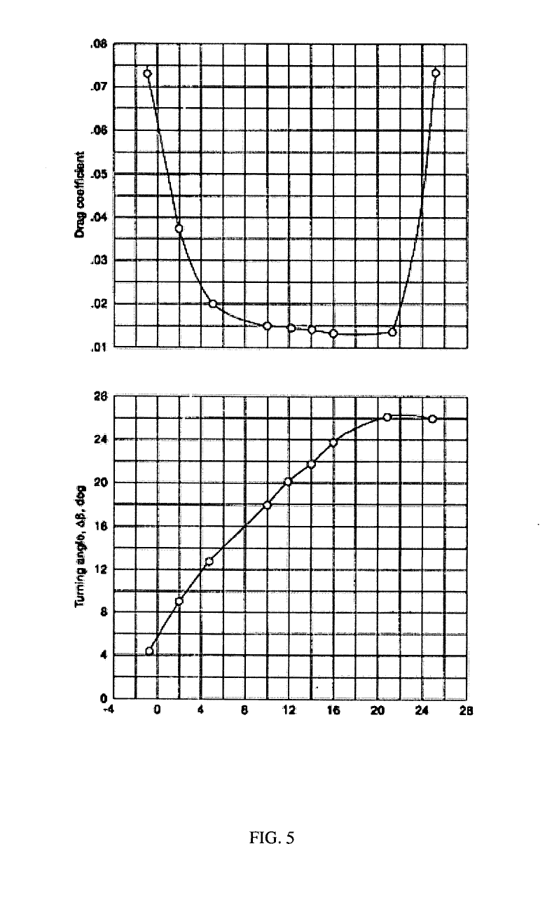

### DETAILED DESCRIPTION LISTING OF ELEMENTS

| ELEMENT DESCRIPTION | ELEMENT # |
|---|---|
| Wind Turbine | 10 |
| Generator | 12 |
| Support | 20 |
| Solar Panel | 22 |
| Casing | 24 |
| Exhaust Vane | 25 |
| Casing First End | 26 |
| Casing Main Body | 27 |
| Casing Second End | 28 |
| Generator | 30 |
| Affixing Member | 32 |
| Stationary Hub | 33 |
| Rotating Shaft | 34 |
| Rotating Hub | 35 |
| Bearings | 36 |
| Rotating Shaft First End | 37 |
| Rotating Shaft Second End | 38 |
| Impeller Blade | 40 |
| Guide Vane Blade | 42 |
| Diffuser | 44 |
| Straightener | 46 |
| Straightener Blade | 48 |

### DETAILED DESCRIPTION

### 1. Design of Multistage Axial Flow Wind Turbine

### 1.1 Consideration of Cascade and Fluid Flow Theories

The aerodynamic design of multistage axial flow wind turbines 10 has been considered on the basis of two principle assumptions: (1) axially symmetric flow; and, (2) blade-element flow.

The axially symmetric flow assumption is primarily a mathematical device that reduces the general flow equation from a three-dimensional to a two-dimensional system. In order to linearize and further simplify the flow equations, several auxiliary flow assumptions are made. The first assumption is considering the flow to be non-viscous and time-steady. Additional assumptions made within the axial symmetry approach include simple radial equilibrium and constant entropy in the radial dimension, and thus the radial variation of entropy is zero (since radial variation of entropy depends upon viscous dissipation of energy and upon radial variations of heat transfer). According to the preceding assumptions, two-dimensional cascade theory and theory of fluid flow constitute the design framework for multistage axial flow wind turbines.

### 1.2 Selection of Design Variables

The design calculations of the multistage turbine blade require first the specification of certain aerodynamic and geometric characteristics. Among these are the inlet values of hub-tip radius ratio, max and min weight flow, and wheel speed. Besides the variation of blade loading and axial wind velocity and tip diameters, an additional parameter specifying the radial distribution of variable velocity in each stage must be considered. In wind turbine design calculations, mean values of all variables of the affecting the above-identified parameters have been considered.

### 1.3 Construction of Multistage Axial Flow Wind Turbine

Before explaining one embodiment of the invention in detail it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

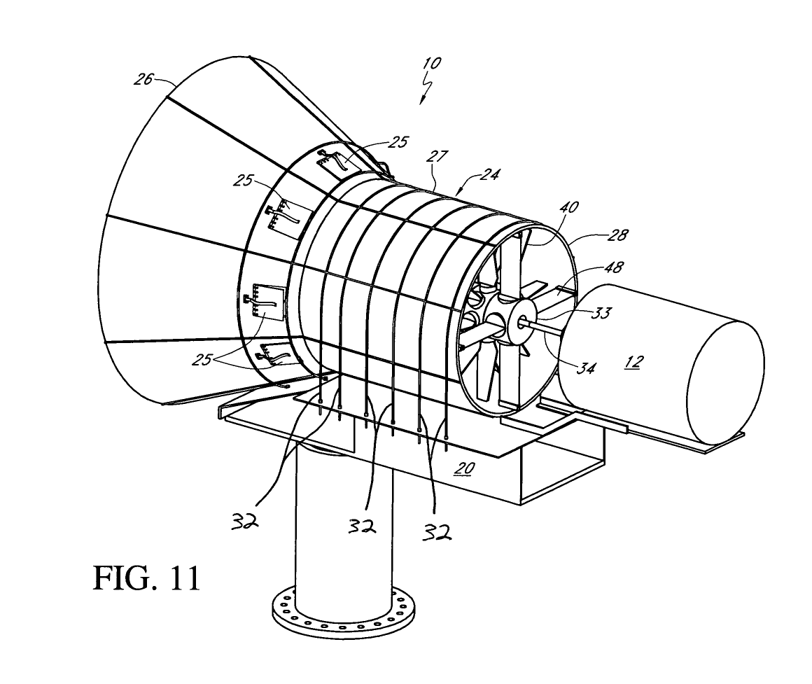

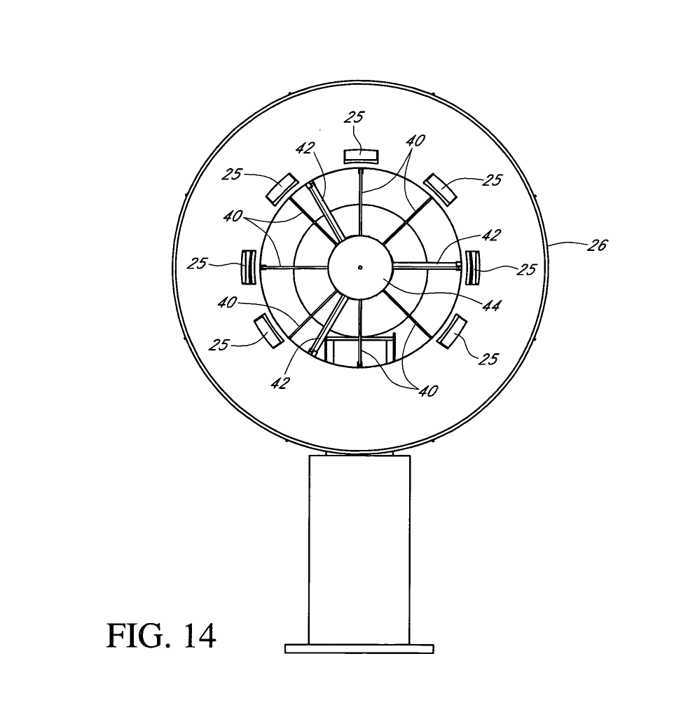

An exemplary embodiment of a wind turbine 10 is shown in FIGS. 11-14. The wind turbine 10 consists of several parts, one of which is the casing 24. The casing 24 is open at both ends, and has a casing first end 26 shaped as a large cone or funnel, which functions to guide large amounts of air flow (i.e., wind) through the interior portion of the casing 24. The casing first end 26 is connected to the casing main body 27, which is cylindrical in shape, as shown in FIGS. 11-13A. The end of the casing main body 27 opposite the casing first end 26 is the casing second end 28, which in the exemplary embodiment has a cross-sectional area equal to that of the casing main body 27. The shape of the casing 24 (large, circular inlet tapered to a cylinder with a constant cross-sectional area in the shape of a circle) increases wind velocity through the casing 24 and steadies the stream lines. In the exemplary embodiment, the inside diameter of the casing main body 27 is maintained with very close tolerances in a circular shape. The interior surface of the casing should be very smooth to reduce frictional loses and increase efficiency of the wind turbine 10. The casing 24 may also be outfitted with exhaust vanes 25, as shown placed in the casing first end 26 in the exemplary embodiment. The exhaust vanes 25 act as pressure reliefs in the event of extremely high wind flow. The pressure at which the exhaust vanes 25 vent may be adjusted for the conditions under which the wind turbine 10 is designed to operate. The exhaust vanes 25 may be placed in other areas of the casing 24 in embodiments not shown herein.

In another embodiment now shown herein, the casing 24 may be fashioned as two separate parts, wherein the two parts are connected via a hinge (not shown) or plurality of hinges and secured with clamps (not shown). This embodiment of the casing 24 would be a clamshell-type design, and the seam between the two pieces may be vertical or horizontal, depending on the specific embodiment. However, a horizontal seam would provide greater ease for assembly and maintenance of the internal portions of the wind turbine 10, such as the impeller blades 40, bearings 36, and the like. Additionally, the casing 24 may be fashioned from more than two separate parts in other embodiments not shown herein.

A rotating shaft 34 with a longitudinal axis concentric to that of the casing 24 is positioned within the interior of the casing 24. The rotating shaft has a first end 37 and a second end 38. Along its length, the rotating shaft 34 is engaged with a plurality of rotating hubs 35 and a plurality of stationary hubs 33. Each rotating hub 35 and stationary hub 33 surrounds a portion of the rotating shaft 34 so that the rotating shaft 34 passes through each rotating and stationary hub 35, 33. The rotating shaft 34 is engaged with the rotating hubs 35 in such a manner that the rotating hubs 35 rotate with and at a rate equivalent to that of the rotating shaft 34. The rotating hubs 35 may be affixed to the rotating shaft 34 by any means known to those skilled in the art, including but not limited to set screws, keyways, welding, rivets, chemical adhesion, or penetrating screws. The rotating shaft 34 is preferably engaged with each stationary hub 33 via bearings 36 positioned within the stationary hub 33 and through which the rotating shaft 34 passes. The exemplary embodiment pictured herein use four stationary hubs 33 and three rotating hubs 35 in an alternating arrangement, but the number of stationary hubs 33 or rotating hubs 35 and their specific arrangement does not limit the scope of the present invention.

A plurality of impeller blades 40 are affixed to each rotating hub 35. The exemplary embodiment shows eight separate impeller blades 40 affixed to each of the three rotating hubs 35 in an equidistant arrangement. The impeller blades 40 are preferably arranged on the rotating hub 35 with equidistant spacing between the impeller blades 40. Other numbers and arrangements of impeller blades 40 may be used without departing from the spirit and scope of the present invention. The impeller blades 40 are shaped and positioned so that air passing through the casing 24 imparts a force to the impeller blades 40 that results in a rotational force and causes the impeller blades 40 to rotate (which subsequently causes the rotating hubs 35 and rotating shaft 34 to rotate as well). Each rotating hub 35 and impeller blades 40 attached thereto represent circular, two-dimensional cascades of blades. The impeller blades 40 may be affixed to the rotating hubs 35 by any means known to those skilled in the art, including but not limited to keyways, welding, rivets, chemical adhesion, or penetrating screws. The opposite ends of the impeller blades 40 are preferably oriented so that the clearance between the tips of the blades and the interior surface of the casing 24 is very low; in some embodiments less than one millimeter. The clearance between the tips of the impeller blades 40 and the interior of the casing 24 will depend on the specific design parameters for each embodiment and in no way limits the scope of the invention.

A plurality of guide vane blades 42 are affixed to each stationary hub 33. The exemplary embodiment shows three separate guide vane blades 42 affixed to each of the four stationary hubs 33. The opposite ends of the guide vane blades 42 are affixed to the interior of the casing 24, and thereby enhance the durability and rigidity of the casing 24 and create a structure similar to a hub-and-spoke arrangement. The guide vane blades 42 thereby serve to ensure the stationary hubs 33 are adequately supported so that the rotating shaft 34 remains properly aligned. The guide vane blades 42 may be affixed to the stationary hubs 33 and/or the interior of the casing 24 by any means known to those skilled in the art, including but not limited to keyways, welding, rivets, chemical adhesion, or penetrating screws.

In the exemplary embodiment, stationary hubs 33 and rotating hubs 35 are arranged in an alternating fashion with the minimum possible clearance between adjacent hubs. In the exemplary embodiment this clearance is preferably less than one millimeter, but may be larger depending on the specific embodiment. The alternating arrangement of stationary hubs 33 and rotating hubs 35, with the first encountered by the wind entering the casing 24 being a stationary hub 33, allows the wind turbine 10 to make the most efficient use of the wind energy. The exemplary embodiment pictured in FIGS. 11-15 includes three stages, wherein a stage is defined as one set of guide vane blades 42 and the stationary hub 33 to which they are attached and the adjacent set of impeller blades 40 and the rotating hub 35 to which they are affixed. As such, other embodiments not shown herein exist having more or less stages than the number shown for the exemplary embodiment, and number of stages in no way limits the scope of the present invention as long as the embodiment comprises at least two rotating hubs 35 and respective impeller blades 40 and one stationary hub 33 and respective guide vane blades 42.

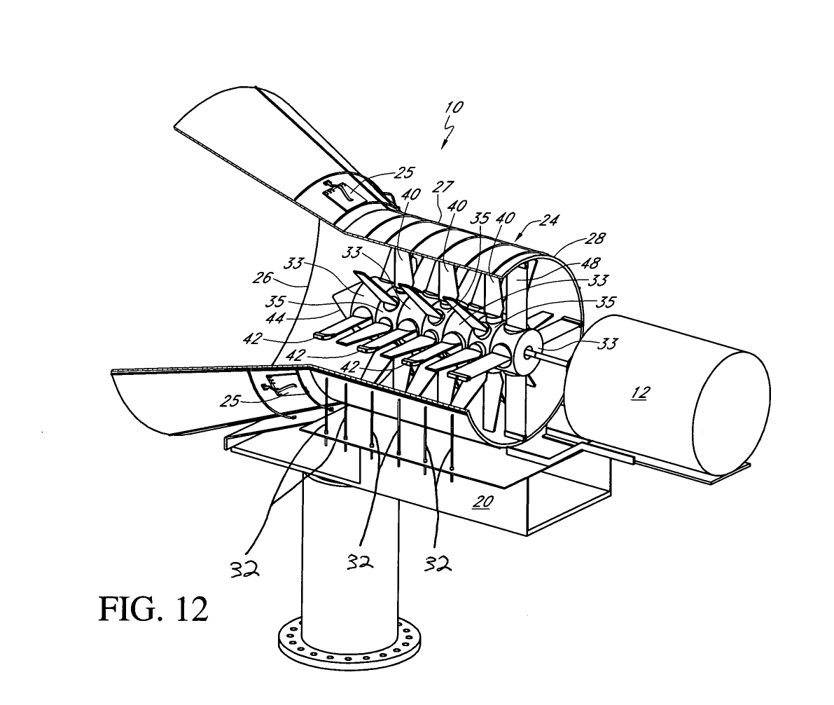

The guide vane blades 42 are preferably arranged on the stationary hub 33 with equidistant spacing between the guide vane blades 42 (as may be seen in FIG. 12) to create a circular, two-dimensional cascade of guide vane blades 42. The guide vane blades 42 are generally shaped in such a fashion and oriented at a different angle than the impeller blades 40 to induce the most efficient force on the impeller blades 40 positioned downstream from the guide vane blades 42. That is, the guide vane blades 42 are designed so that they direct the wind that has passed through the adjacent upstream impeller blades 40 into the adjacent downstream impeller blades 40 with the most force available by efficiently directing the wind flow with the minimal amount of aerodynamic resistance. Other numbers and arrangements of guide vane blades 42 may be used without departing from the spirit and scope of the present invention.

In the exemplary embodiment, a straightener 46 is positioned just downstream of the rotating hub 35 closest to the casing second end 28. In the exemplary embodiment, the straightener 46 is comprised of four straightener blades 48 spaced equidistant from each other, but may take other embodiments. The straightener blades 48 are affixed to a stationary hub 33 at one end of the straightener blade 48 and the interior of the casing 24 at the opposite end in a manner corresponding to that of the guide vane blades 42. The straightener 46 serves to untwist the discharge of wind flow through the casing 24 and eliminate wake formation. The straightener 46 also guides the flow in an axial direction, and thereby reduces energy losses through the casing 24.

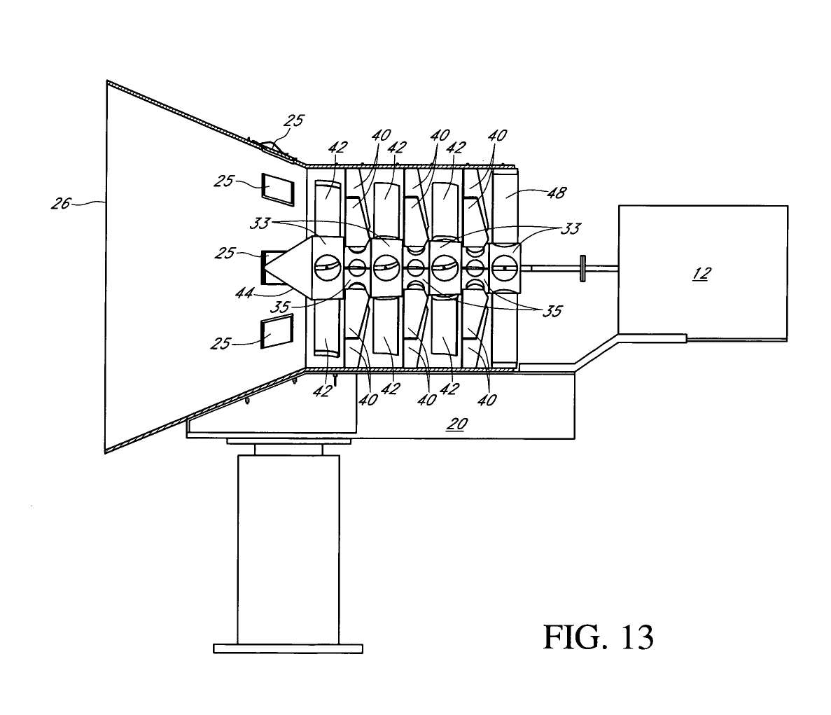

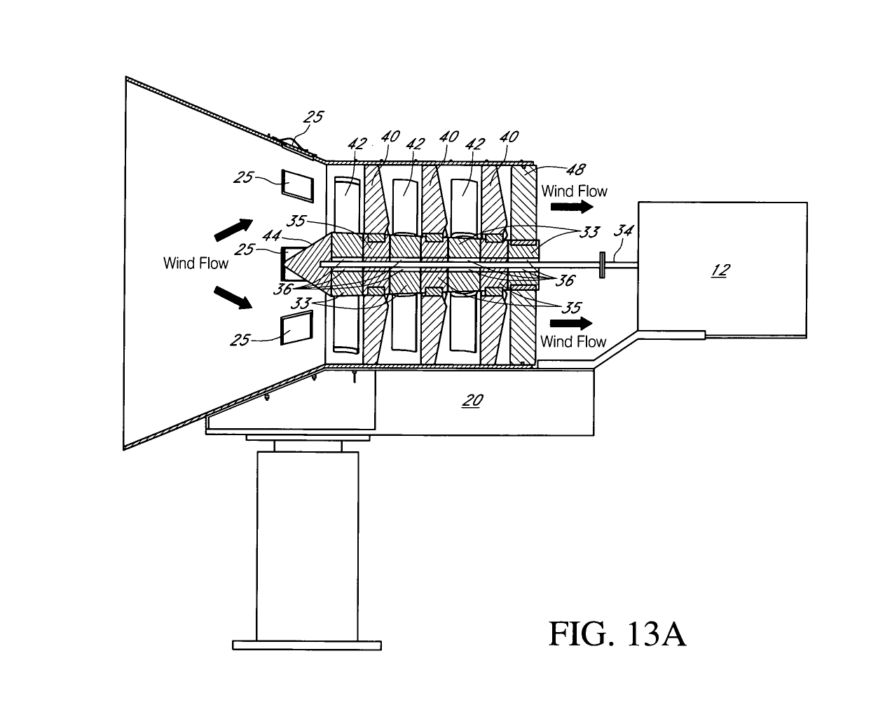

The rotating shaft first end 37 (positioned adjacent the casing first end 26, which provides for the wind inlet into the casing 24 and the wind turbine 10) may be rotatably engaged with a diffuser 44. The diffuser 44 is the first structure incoming wind encounters as it passes through the tapered casing first end 26. The function of the diffuser 44 is to guide the wind into the interior of the casing 24 and gradually increase the flow velocity through the casing first end 26 and thereafter maintain the axial velocity through the casing main body 27 as constant as possible for as long of distance along the casing main body 27 as possible. To that end, the diameter of the rotating hubs 35 and stationary hubs 33 may be gradually deceased from the casing first end 26 to the casing second end 28, as is best seen in FIG. 13. In another embodiment, the diffuser 44 may be affixed to the stationary hub 33 closest to the casing first end 26 so that the diffuser 44 does not rotate, or the diffuser 44 may be affixed to the rotating shaft first end 37 so that it rotates with the rotating shaft 34. In the exemplary embodiment, the diffuser 44 is affixed to the stationary hub 33 closest to the casing first end 26.

In the exemplary embodiment, the rotating shaft second end 38 is coupled to a generator 12 that converts mechanical energy into electricity. In an alternative embodiment not shown herein, the rotating shaft second end 38 may be engaged with a gearbox (not shown). The gearbox in turn is engaged with a generator 12 that converts mechanical energy into electrical energy. The gearbox functions to take the input rotational velocity of the rotating shaft 34 and either increase or decrease that rotational velocity (depending on the generator 30) to a specific output velocity for rotating a generator 30. Alternatively, the gearbox may be fashioned so that it is capable of converting a plurality of different input rotational velocities to one specific output velocity; or it may be fashioned so that it is capable of delivering a plurality rotational output velocities regardless of input rotational velocity. The gearbox may be integral to the generator 12 or may be a separate structure.

The impeller blades 40, guide vane blades 40, diffuser 44, casing 24, stationary hubs 33, rotating hubs 35, rotating shaft 34, and straightener blades 48 may be made of highly strong engineering thermoplastic materials, aluminum alloys, carbon fiber, or any other materials known to those skilled in the art that are suitable for the application. It may be that light weight materials also having sufficient strength to withstand wind forces will be desirable for an application. Furthermore, a light weight impeller will consume less energy for its own rotation and, therefore, will often contribute to a more efficient wind turbine 10.

Impeller blades 40, guide vane blades 42, and other elements of the wind turbine 10 comprising the exemplary embodiment are designed in considerably smaller sizes compared to the size of larger, fan-type wind turbines. Because of the smaller size, many elements may be easily molded of the proper polymer. Some of the elements may also be made of fiberglass reinforced plastic. Gears within the gearbox may be made of self-lubricated nylon or polymer materials, or any other suitable material known to those skilled in the art. Consequently, the manufacturing cost of multistage axial flow wind turbines 10 may be considerably less than that of conventional, fan-type turbines, and the cost of the wind turbine 10 per unit of power generated will be much less for multistage axial flow wind turbines than for conventional turbines.

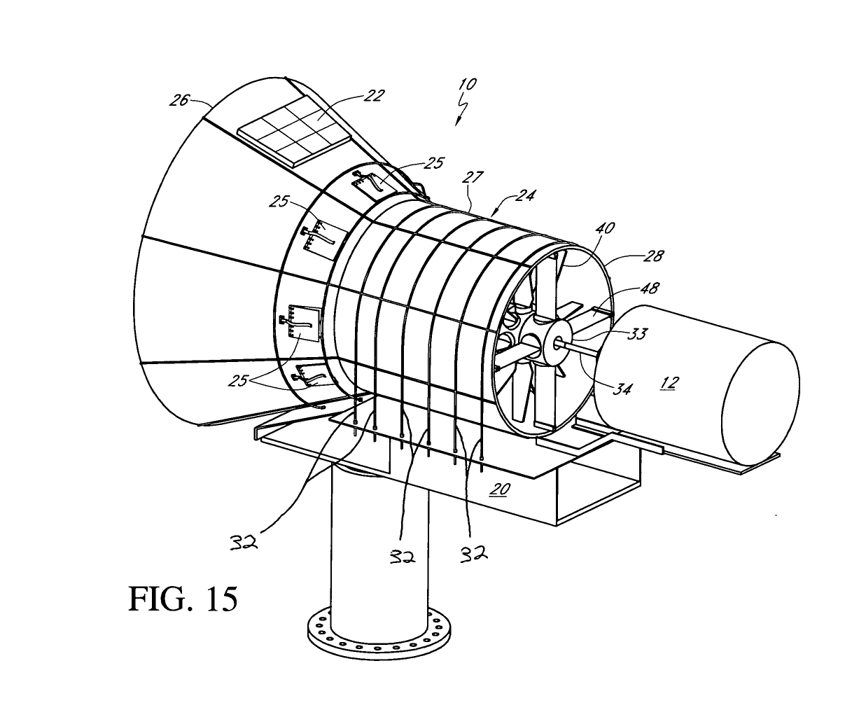

In the exemplary embodiment shown in FIG. 15, a solar panel 22 is placed on the exterior of the casing 24. The solar panel 22 may be of any type known to those skilled in the art that is operable to convert solar energy into electricity. The solar panel 22 simply serves to increase to total electrical generating capacity of the wind turbine 10, and may or may not be used depending on the particular embodiment of the wind turbine 10. In other embodiments not shown herein, a plurality of solar panels 22 may be placed on the exterior of the casing 24 to further increase the electrical generating capacity of the wind turbine 10.

Generally, the wind turbine 10 is affixed to a support 20. FIGS. 11-13 show the support 20 affixed to the bottom portion of the casing 24 using affixing members 32. The affixing members 32 may be made of any suitable material for the application of the wind turbine 10, such as wire, cable, metallic bands, polymer, or the like. The support 20 provides for a mounting location for the wind turbine 10. In many applications, it is desirable for the support 20 (and hence, the wind turbine 10) to be rotatable with respect to the structure on which the wind turbine 10 and support 20 are mounted. This rotation allows for the wind turbine 10 to be positioned in the most advantageous angle with respect to the wind direction for maximum efficiency. A powered rotor (not shown) may be engaged with the support 20 to manipulate the rotational position of the support 20 and the wind turbine 10, or the position may be achieved manually and a manual positional lock (not shown), such as a pin and corresponding holes through which the pin may pass may be used. Any means for manipulating the position of the wind turbine 10 and/or support 20 known to those skilled in the art may be used, and the particular means used in no way limits the scope of the present invention.

Although not shown, it is contemplated that multiple wind turbines 10 may be used in relatively close proximity to each other. For example, several wind turbines 10 may each use a separate support 20 but use a common mounting structure in such a manner that the wind turbines 10 are stacked on top of each other in a linear fashion.

### 1.4 Design of Multistage Axial Flow Wind Turbine

Having described the physical characteristics and orientations of the several elements of a multistage axial flow wind turbine 10, the design method and the parameters and/or variables of concern will now be discussed.

In an axial flow wind turbine, energy is carried from the wind flow through impellers blades 40 to the rotating shaft 34. Since wind force rotates the impeller blades 40 of the wind turbine 10 (opposite to the power flow in an air compressor) the wind flow is somewhat twisted in the process.

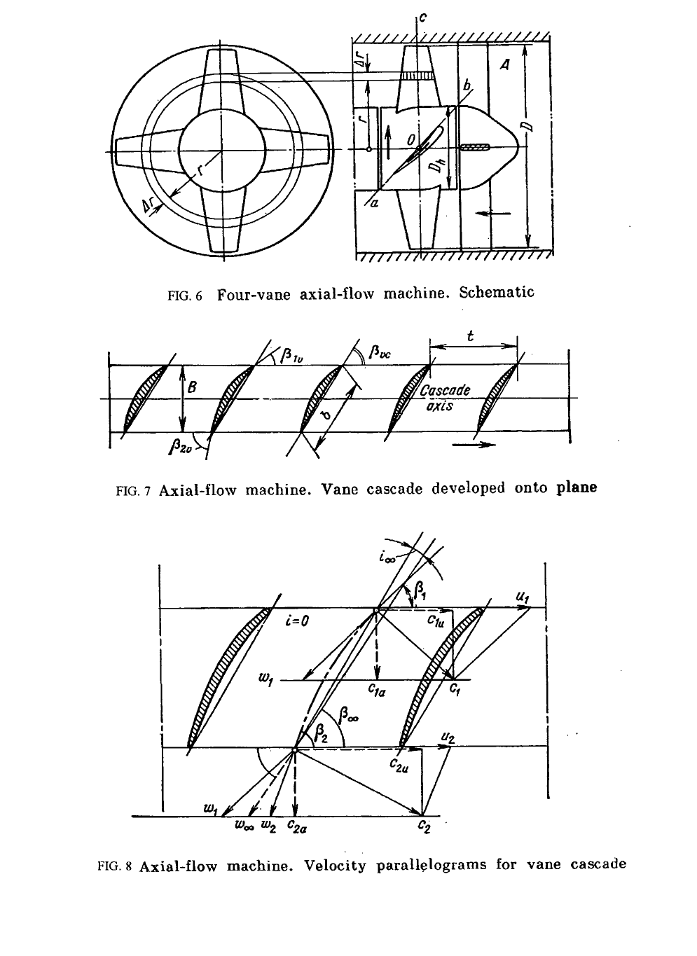

The performance and design of an axial flow turbine is similar to axial flow air compressors, and the theory of cascade profiles for such air compressors is useful. If the impeller is sectioned by a cylinder of radius r as indicated in FIG. 6, the development of the impeller together with the vane sections will give a plane cascade of vane profiles for the axial flow machine involved. FIG. 7 shows the vane cascade developed onto a plane. The cascade geometry is characterized by the following symbols:

t=vane spacing equal to the distance between the corresponding points of vane section measured in the direction of cascade movement;
b=length of vane section (profile) cord;
B=cascade width measured parallel to the axis of rotation;
β₁ᵥ and β₂ᵥ=vane entry and discharge angles, respectively; and,
β_{vc}=vane angle (i.e., the angle between the vane chord and cascade axis).

The cord-vane spacing ratio is defined as p, wherein p=b/t, the inverse of the chord-vane spacing ratio is referred to as pith ratio, τ, wherein τ=1/p=t/b.

The construction of entrance and exit velocity parallelograms, as shown in FIG. 8, makes it possible to introduce the main kinematic parameters of flow through a cascade:

u₁=drift at inlet;
w₁, c₁=relative and absolute inlet velocities, respectively;
u₂=drift at discharge;
w₂, c₂=relative and absolute discharge velocities, respectively;
β₁ and β₂=entry and discharge angles, respectively (i.e., the angles between the cascade axis and relative inlet and discharge velocity);
i=cascade vane angle of attack between the vane chord and the direction of average relative velocity w_{∞}; and,
Lth=specific energy imparted to air in impeller channels.

From the velocity parallelograms shown in FIG. 8 it follows that a cascade of profiles changes the relative and absolute velocities in magnitude and direction. The characteristic feature is the twisting effect produced on the flow by the cascade (c₂ᵤ>c₁ᵤ).

The axial flow turbine is made up of several pressure stages. Each stage comprises a set of rotating impeller blades 40 and a set of stationary guide vane blades 42, both being circular two-dimensional cascades of blades. As explained above, the impeller blades 40 are attached to rotating hubs 35 and the guide vane blades 42 are rigidly fixed to the casing 24 at one end of the guide vane blade 42 and to the stationary hubs 33 at the opposite end of the guide vane blade 42 to hold the rotating shaft 34 and the bearings 36 within the stationary hubs 33 in the central axis of the casing 24.

The geometry and shape of both the impeller blades 40 and the guide vane blades 42 for an axial flow wind turbine 10 are similar to the geometry and shape of blades for an axial flow air compressor. Therefore, design norms should be the same each, and the theoretical equations for axial flow air compressors have been taken herein as to suit the requirements of the functional aspects of wind turbines 10.

Continuity equation: ρ₁Ω₁c₁=ρ₂Ω₂c₂ (4.1)

This equation is applied to an axial flow machine assuming that the vane length is Δᵣ (see FIG. 6). Within a small length of Δᵣ velocities can be considered invariable. In this case the inlet and discharge areas are equal, (i.e., Ω₁=Ω₂=tΔᵣ).

In equation 4.1 vectors c₁ and c₂ are normal to sectional plane, respectively. Therefore, assuming that Ω₁ and Ω₂ are normal to the machine centerline, c₁ and c₂ should be regarded as axial components of absolute velocity.

From FIG. 8 it is inferred that c₁ₐ=ω₁ₐ and c₂ₐ=ω₂ₐ. Hence, on cancellation of Ω₁ and Ω₂ the continuity equation can be written as ρ₁c₁ₐ=ρ₂c₂ₐ}, and substituting the values above yields

ρ₁ω₁ₐρ₂ω₂ₐ} (4.2)

For incompressible fluid ρ₁=ρ2 are constant, which yields

c₁ₐ=c₂ₐ=cₐ} (4.3)

ω₁ₐ=ω₂ₐ=ωₐ} (4.4)

The flow, in the process of its relative motion through the impeller of an axial flow machine, is simply the conversion of energy from kinetic to potential.

As the specific kinetic energy of relative motion changes steadily from w₁²/2 to w₂²/2, the pressure and density vary continuously, and the energy equation can be written as

w₁²/2−w₂²/2=∫₁²dp/ρ+ΔL (4.5)
where ΔL=specific energy transforming into heat.

The variation of potential energy expressed by the integral on the right side of equation (4.5) may be calculated if the relationship between P and P₁, and consequently, the thermodynamic process in the machine impeller channel are known. The process is isothermal in a wind turbine 10 since the temperature does not change during isothermal operations, and the process is polytropic in the case of axial flow air compressors.

The energy added to the flow by a cascade of impeller vanes can be calculated from the basic equation where u₂=u₁=u, which yields

Lₜₕ=u(c₂ᵤ−c₁ᵤ)=uΔcᵤ, wherein Lₜₕ is equal to the specific energy imported to fluid in impeller channels.

From the velocity parallelograms of FIG. 8, it follows that c₂ᵤ=u₂−c₂ᵤ ctg β₂; c₁ᵤ=u₁−c₁ᵤ ctg β₁. By inserting the values of c₂ᵤ and c₁ᵤ into the expression for Lₜₕ and using equation 4.3, one is left with Lₜₕ=u cₐ(ctg β₂−ctg β₁).

The force exerted on the fluid flow by the impeller blades 40 in the case of an axial flow air compressor may be determined using the momentum equation and the Kutta-Zhukowsky theorem. As previously described, the function of an impeller for a wind turbine 10 is opposite that of the function of an impeller for an air compressor. The basic physical principles involved in wind turbine blade design using the momentum equations and Kutta-Zhukowsky theorem are considered opposite to those indicated in the velocity parallelograms (FIG. 8) for the forces considered in air compressor blade design.

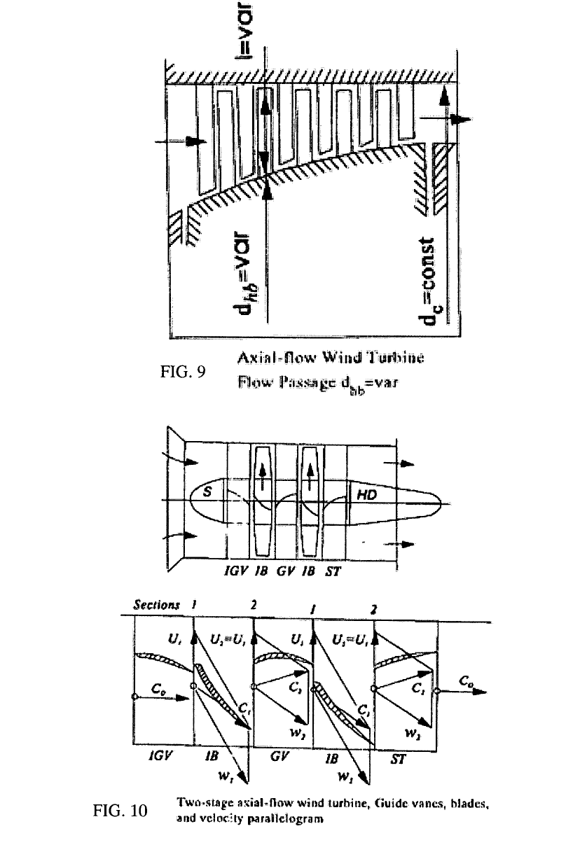

In accordance with the shape of the casing 24 interior surface and the rotating hubs 35 and stationary hubs 33 outer surfaces, a distinction is made between flow passage geometry as shown schematically in FIG. 9 noted by the variables d_{hb} and d_{c}, which are variable and constant diameter flow passage cross sections, respectively. In FIG. 9, the radial length of impeller blades 40 and guide vane blades 42 decreases from the first stage to the last stage. This variation of blade length is designed to ensure the axial velocity of the wind is constant as far as possible along the length of the casing 24.

Longer blades decrease energy losses in the stages closer to the casing second end 28. Because d_{hb}=variable and d_{c}=constant, smaller radial clearances are allowed between the impeller blade 40 tips and the interior of the casing 24, which increases the volumetric efficiency of stage. Thus, the peripheral wind flow velocities of the impeller blades 40 will not significantly decrease and axial velocity will remain essentially constant. Therefore, torque output of each successive of stage also will be essentially constant so that total torque output of the wind turbine 10 is the summation of the torque of each stage. Certain aspects of this result are shown graphically from the velocity parallelograms for blade cascades in a two-stage axial flow turbine are shown in FIG. 10. Further discussion regarding blade length, angle, and pitch may be found in Hydraulic Machines: Turbines and Pumps by Grigori Krivchenko (2nd sub ed. 1994), which is incorporated by reference herein but not discussed further herein as to not obscure the inventive features of the disclosure.

It should be noted that the present invention is not limited to the specific embodiments pictured and described herein, but is intended to apply to all similar apparatuses for generating electricity from wind flow. Accordingly, modifications and alterations from the pictured and/or described embodiments will occur to those skilled in the art without departure from the spirit and scope of the present invention.

1. A wind turbine comprising:
a. a casing with an inlet and outlet;
b. a rotating shaft positioned within said casing wherein said rotational shaft provides rotational power to a generator;
c. a plurality of impeller blades and guide vane blades arranged in at least one set within an interior of said casing, wherein said set comprises:
i. a plurality of guide vane blades wherein each guide vane blade is affixed to an interior surface of said casing and to a stationary hub surrounding said rotating shaft, wherein a bearing is positioned within said stationary hub and rotationally engages an outer surface of said rotating shaft; and,
ii. a plurality of impeller blades affixed to a rotating hub, wherein said rotating hub is affixed to said rotating shaft and rotatable therewith, and wherein said plurality of impeller blades are rotatable within said casing.

2. The wind turbine according to claim 1 wherein said plurality of guide vane blades of each said set is arranged upstream of said plurality of impeller blades of each said set.

3. The wind turbine according to claim 1 further comprising a solar panel affixed to a portion of the casing.

4. The multistage axial flow wind turbine according to claim 1 further comprising a straightener mounted within said casing.

5. The wind turbine according to claim 1 further comprising a gearbox, wherein said rotating shaft is coupled to said gearbox, and wherein said gearbox is coupled to said generator.

6. The wind turbine according to claim 1 wherein said casing and said rotating shaft are concentric.

7. The wind turbine according to claim 1 wherein said plurality of impeller blades is further defined as including eight impeller blades.

8. The wind turbine according to claim 1 wherein said plurality of guide vane blades is further defined as including three guide vane blades.

9. The wind turbine according to claim 1 wherein said at least one set is further defined as including three sets.

10. The wind turbine according to claim 1 in combination with a plurality of wind turbines according to claim 1, wherein said plurality of wind turbines are connected to an electrical power grid.

11. The wind turbine according to claim 1 wherein said casing further comprises at least one exhaust vane.

12. The wind turbine according to claim 1 wherein said wind turbine is mounted to a support.

13. The wind turbine according to claim 12 wherein said support is rotatable.

14. The wind turbine according to claim 12 wherein a plurality of wind turbines are mounted to said support.

15. The wind turbine according to claim 1 wherein said casing is further defined is further defined as at least two cooperative portions.

16. A wind turbine comprising:
a. a casing having a first and second end, wherein said first end is fashioned as substantially in the shape of a funnel, wherein said second end is shaped substantially as a cylinder, and wherein said first and said second ends are connected by a casing main body having substantially the same shape and cross-sectional area as said casing second end;
b. a rotating shaft positioned within said casing having a first and second end wherein said rotating shaft second end provides rotational energy to a generator;
c. a plurality of guide vane blades and impeller blades arranged in a plurality of sets within an interior of said casing, wherein each said set comprises:
i. a plurality of guide vane blades having a first and second end, wherein said guide vane first end is affixed to an interior surface of said casing, wherein said guide vane second end is affixed to a stationary hub surrounding said rotating shaft, wherein a bearing is positioned within said stationary hub and rotationally engages an outer surface of said rotating shaft, and wherein said rotating shaft first end is engaged with a first stationary hub positioned adjacent said casing first end; and
ii. a plurality of impeller blades having a first and second end, wherein said impeller blade first end is arranged so that the clearance between said impeller blade first end and said interior is between 0.1 millimeters and 20 centimeters, wherein said impeller blade second end is affixed to a rotating hub, wherein said rotating hub is affixed to said rotating shaft and rotatable therewith, wherein said plurality of impeller blades is arranged towards said rotating shaft second end, and wherein said plurality of guide vane blades is arranged towards said rotating shaft first end.

17. The wind turbine according to claim 16 further comprising a plurality of straightener blades having first and second ends, wherein said straightener blade first end is affixed to said interior of casing, and wherein said straightener blade second end is affixed to a stationary hub.

18. The wind turbine according to claim 16 further comprising a solar panel affixed to said casing.

19. The wind turbine according to claim 16 wherein said casing and said rotating shaft are concentric.

20. The wind turbine according to claim 16 further comprising a gearbox, wherein said rotating shaft second end is coupled to said gearbox, and wherein said gearbox is coupled to said generator.

21. The wind turbine according to claim 16 wherein said plurality of guide vane blades of each said set is arranged upstream of said plurality of impeller blades of each said set.

22. The wind turbine according to claim 21 further comprising a solar panel affixed to a portion of the casing.

23. The wind turbine according to claim 22 wherein said wind turbine is mounted to a support.

24. The wind turbine according to claim 23 wherein said support is rotatable.

25. The wind turbine according to claim 16 in combination with a plurality of wind turbines according to claim 16, wherein said plurality of wind turbines are connected to an electrical power grid.
